(19) United States
(12) Patent Application Publication
(10) Pub. No.: US 2003/0224141 A1
(43) Pub. Date: Dec. 4, 2003

(54) Reinforcement product

(75) Inventors: Jerome Maupetit, Soyons (FR); Francisco Machado-Valente, Le Cheylard (FR); Jacques Baudonnel, Le Cheylard (FR)

Correspondence Address: Ira J. Schultz, DENNISON, SCHULTZ & DOUGHERTY, Suite 612, 1745 Jefferson Davis Highway, Arlington, VA, 22202, US

(73) Assignee: Chomarat Composites

(21) Appl. No.: 10/395,882

(22) Filed: Mar. 25, 2003

(30) Foreign Application Priority Data
Apr. 1, 2002 (FR) 02 04 091

(51) Int. Cl. B32B 5/12

(52) U.S. Cl. 428/109; 428/107; 428/105

(57) ABSTRACT

A reinforcing product includes a first layer (2) of reinforcing threads (3) parallel to each other and a second layer (4) of reinforcing threads (5) parallel to each other and transverse to the first layer (2). The reinforcing threads (3) in the first layer (2) are partially covered by a powder based on a thermoplastic or thermosetting material forming a bond firstly at points between the reinforcing threads (3) in the first layer (2), and secondly between the reinforcing threads (3) in the first layer (2) and the reinforcing threads (5) in the second layer (4).

This invention relates to the field of reinforcing products with a coherent nature, particularly designed to form reinforcement.

The main purpose of the invention is products for use as reinforcement to be built into a matrix.

In many fields, it is desirable to be able to reinforce a manufactured product so as to improve some mechanical characteristics provided by the component material used to make the composite product.

Thus, it is known how to use reinforcement, particularly in cement, concrete, plastics and resins.

This type of reinforcement may be composed from a lattice network that is made or produced from fibres that may be single-directional for some applications or woven in variable width strips.

Prior art also offers other solutions: for example, French patent published as No. FR 2 792 952 proposes an open mesh type product composed of at least a first tight layer of reinforcing threads and a transverse strip of reinforcing threads, the said threads being crossed without interlacing and therefore without warp shrinkage and being at least locally bonded together by melting of bonding material based on an at least partially molten thermoplastic material. In this case, the bond between the two layers is formed by bonding fibres or threads made at least partly from a thermoplastic material. Note also that this type of bonding fibre may advantageously be formed by a component material made of threads in the two transverse layers, after having been subjected to a coating or cladding phase with a thermoplastic material.

Thus in this type of reinforcement, when the bonding fibres or threads are present in small quantities, the layers forming the mesh are only bonded at the bonding threads or fibres. Therefore, bonding between layers is not uniform within the reinforcing member, which can cause problems after the resin has been injected. The composite material obtained is not homogenous, and consequently there are risks of cracking. Furthermore, during implementation, in other words after cutting and creep in the resin, fibres in the least bonded areas cause quality or mechanization defects by modifying reinforcement placements.

On the other hand, when the layers are composed essentially of threads coated with or clad in a thermoplastic material, the bond between the different layers is undoubtedly more homogenous, but the coating or cladding forms a film screen for the injected matrix over the entire developed area of the threads. Furthermore, such coated threads are stiff and less easily manipulated.

The purpose of the invention is to overcome these disadvantages by proposing a new reinforcement or reinforcing product in plane form with a coherent nature, while having a large surface area compatible with subsequent impregnation of the reinforcement product with a resin type matrix. A coherent nature means that the reinforcement is made to have inherent strength, capable of resisting some manipulation stresses or even implementation stresses to obtain a semi-finished product afterwards.

Another purpose of the invention is to provide a reinforcing product with a more uniform bond between reinforcing threads, enabling cutting.

Another purpose of the invention is to propose a reinforcing product with sufficient suppleness to enable the production of composite parts with a moulded shape.

Another purpose of the invention is to propose a new product that can be easily made industrially in various widths at an attractive cost price, and to present aperture factors appropriate for the target applications.

In order to achieve these objectives, the new product according to the invention comprises a first layer of reinforcing threads parallel to each other and a second layer of reinforcing threads parallel to each other and transverse to the first layer, the reinforcing threads in the first layer being partially covered by a powder based on a thermoplastic or thermosetting material forming a bond firstly at points between the reinforcing threads in the first layer, and secondly between the reinforcing threads in the first layer and in the second layer.

Another purpose of this invention is a process for making a reinforcing product according to the invention comprising the following steps:

a) a first layer of reinforcing threads parallel to each other is created and is then past into powder based on a thermoplastic or thermosetting material,

b) the first layer thus obtained is then vibrated, to eliminate some of the powder deposited on the surface of the reinforcing threads,

c) a second layer of reinforcing threads parallel to each other is deposited on the first layer, the second layer being transverse to the first layer without any interlacing,

d) the two layers are assembled by thermocompression.

Various other characteristics of the subject of the invention will become clear after reading the following description with reference to the attached drawings that show embodiments of the purpose of the invention as non-limitative examples.

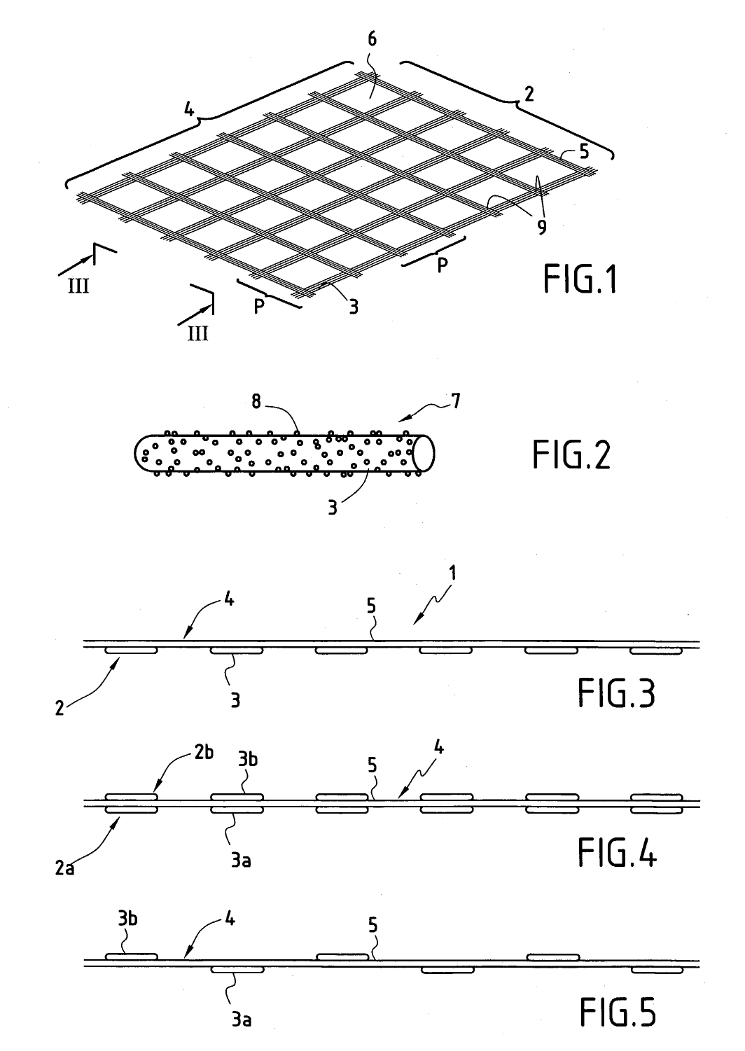

FIG. 1 is a partial perspective view diagrammatically showing a portion of the new product according to the invention.

FIG. 2 is a perspective diagrammatic view, deliberately at larger scale, showing a reinforcing thread in the first layer.

FIG. 3 is a partial section approximately along plane III-III in FIG. 1, but at a larger scale.

FIG. 4 is a section similar to FIG. 3, but illustrating another variant embodiment.

FIG. 5 is a section similar to FIG. 3, but illustrating another variant embodiment.

FIGS. 1 and 2 show that the new product, denoted as a whole by reference 1, is composed of at least one first layer 2 of reinforcing threads 3 in tension and parallel to each other at constant intervals from each other in the example illustrated. These reinforcing threads 3 may be qualified as warp threads, in analogy to a manufacturing process similar to weaving.

The new product 1 is also composed of a second layer 4 of reinforcing threads 5 that also extend parallel to each other, and also at constant intervals from each other in the example, preferably but not necessarily identical to the interval determining the spacing between the threads 3. Also by convention, the threads 5 may be qualified as being weft threads, and in the example illustrated extend along a general direction orthogonal to the direction of the threads 3. However, it should be considered that an oblique orientation would also be possible.

The layer 4 of threads 5 is placed on the same side as the layer 2, being under it or over it.

For threads 3 and 5, it can be decided to use a single strand with a circular or similar prismatic cross-section, or a flat or multi-filamentary single strand, spread out or not, or it may be organized such that the filaments are parallel to each other to form a bundle of filaments, also called roving. The reinforcing threads may be completely or partly textured or expanded.

The threads 3 are preferably of the same nature and composition for the entire layer 2. The same is true for threads 5, that may have a different nature and composition from threads 3 if required.

As an example, the threads 3 and 5 may be entirely or partly based of glass fibre, carbon, aramide, high strength polyethylene terephthalate or polyamide. As a non-limitative example, the reinforcing threads 3 and 5 may independently have a content of between 20 and 1 000 tex for aramide threads, between 68 and 9 600 tex for glass threads and between 68 and 6 000 tex for carbon threads.

According to the invention, the threads in layers 2 and 4 are preferably arranged in regularly spaced roving, but it would be possible to arrange them in either and/or in both of the layers, so that they cover almost 100% of the surface concerned, being arranged side by side and touching each other.

In the case of threads at a spacing from each other, it should be considered that the spacing p between the threads 3 and the threads 5 defines a mesh 6 that characterizes the open mesh product with an aperture factor. In this respect, the view in FIG. 1 is simply one illustration of an example, given that according to the invention, any shape and dimension of meshes 6 can be selected, particularly by selecting a different spacing p between threads 3 in layer 2 and between threads 5 in layer 4. Advantageously, the spacing will be identical in each layer, and will be between 0.5 and 20 cm.

According to the invention, the threads 5 in layer 4 do not intersect and are not interlaced with the threads 3, but on the contrary are placed on or deposited on these threads.

Layers 2 and 4 are associated with each other in such a way that the behaviour of the new product 1 has a coherent nature. Consequently, the threads 3 in layer 2 are partially covered by a powder 7 based on a thermoplastic or thermoset material.

Powder means a set of grains or particles 8. As can be seen in FIG. 2, these grains 8 partially cover the developed area of the threads 3. Preferably, the average diameter of these grains 8 is between 50 and 500 μm. The size of the grains 8 of powder 7 is adapted to the size of the reinforcing threads 3 to facilitate the bonding effect on the fibre by static effect.

A powder could be used composed at least partly of a thermoplastic material chosen particularly from among polyethylene terephthalate, polyamides, ethylenevinylacetate, and polyolefin resins.

The powder 7 may also be based on a thermosetting material chosen for example from among epoxy resins, urea-formol, vinyl polyacetate, unsaturated polyesters.

These thermoset materials are obtained by a cross-linking, setting, or commonly baking type of transformation, using thermosetting systems. These types of thermosetting systems usually contain a prepolymer or a thermosetting resin, a cross linking agent or hardener or possibly other additives.

Advantageously, the density of the powder 7 is between 0.9 and 2 g/cm³ and the mass of the powder 7 corresponds to 1 to 10% of the total mass of the reinforcing product.

During the design of the product 1, the first layer 2 of the reinforcing threads 3, parallel to each other, is formed using a conventional process and installation, for example as described in French patent published as number FR 2 792 951. This layer 2 is then freely passed into a powder tank and the powder is deposited on the threads 3 by a static effect. In order to adjust the quantity of powder bonding to the threads 3 by electrostatic effect, the layer 2 is vibrated, thus eliminating some of the deposited powder.

The second layer 4 of weft threads 5 is then deposited without interlacing on the first layer 2. The two layers are then assembled together by thermocompression. Before depositing the second layer 4, the first layer 2 may be heated to a temperature just sufficient to soften the powder and thus improve its attachment to the reinforcing threads 3.

If the powder is based on thermoplastic material, the layer 2 of warp threads 3 supporting the layer 4 on which weft threads 5 are deposited is moved into a temperature rise section to at least partially soften or melt the powder to bond the warp threads 3 to each other and the two layers to each other at their intersection 9. Obviously, the softening temperature of the thermoplastic material is less than the softening temperature of the material from which the reinforcing threads are made.

If the powder is based on thermosetting material, the temperature rise step is done at a sufficiently high temperature to make the powder melt. Thermal activation must be sufficient to enable cross-linking and obtain a thermoset material. A person skilled in the subject will easily be able to determine the appropriate temperature, as a function of the specific nature of the powder used.

As an example of operating conditions capable of achieving this result, there may be a temperature rise of the order of 160 to 230° C. in a containment depending on the matrix materials used, followed by setting up a pressure by calandering between 0.5 to 5 bars and then forced cooling to ambient temperature. For example, a diglycidyl bisphenol A ether epoxy resin with an average molecular weight of more than 700 g/mol could be used in the form of a powder with an average particle size of between 220 and 240 μm. This is a solvent free resin which eliminates environmental problems and reduces energy needs, and contains an appropriate cross-linking agent integrated into the powder. Before thermosetting, this resin behaves like a thermoplastic with a low softening point. During the design of the reinforcing product 1, the assembly is subjected to controlled gelification to achieve spot gluing (20 s at 200° C.), followed by complete cross linking to acquire mechanical performances, followed by cooling to ambient temperature.

The bond between the threads is made during this step by means of the grains 8 of powder 7. It is obvious that this thermocompression step causes some deformation of grains 8 of powder 7.

The last step in the process consists of passing the reinforcing product into a cooling section to solidify the junction points and to make the manufactured product coherent and strong.

Note that warp threads are kept under tension during all steps in the process.

FIGS. 4 and 5 show a variant embodiment in which the new open product 1 is made from two tight layers 2a and 2b that satisfy the characteristics mentioned above and between which the threads 5 of layer 4 are arranged without interlacing. The layers 2a and 2b are both powdered and are obtained as described above for layer 2. Once powdered, the two warp layers 2a and 2b join together with the layer 4 of weft threads 5 on a formation cylinder that is conventional in this type of installation, in order to make the assembly by thermocompression. During the thermocompression, a surface or visible film may be formed on one of the two faces of the reinforcing product 1. For example, this surface or visible film may be in the form of a polyester film, a glass film, a decor film, a leak tightness film or a multifunction complex.

In this type of embodiment, as illustrated in FIG. 4, the threads 3a and 3b making up layers 2a and 2b are arranged in superposed planes, while a variant according to FIG. 5 consists of arranging the layer 2a alternately to layer 2b, for example at half the spacing between two threads 3 making up the same layer.

Thus, the product 1 according to the invention may be obtained simply and cleanly. This type of product 1 can also easily be stored, it can easily be manipulated and cut. Due to its structure and the presence of spot bonding, this type of product is also characterized by ease of elastic deformation and suppleness, so that it can be provided in rolled form if required.

Obviously, the new product according to the invention may be made in any width, at an attractive cost price, without requiring particularly complex installations.

Furthermore, the made up reinforcing product 1 has improved compatibility with the matrices in which it will be eventually embedded. A part of the surface of the reinforcing threads 3 is easily accessible to any subsequently injected resin. The powder 7 only partially covers the surface of the reinforcing threads 3. Advantageously, the powder 7 covers less than 5% of the developed surface area of the reinforcing threads 3, and preferably less than 0.5%. The threads may also open up to improve wettability and impregnation of the resin, which gives a more homogenous composite part with improved mechanical performances.

Furthermore, consideration of FIG. 1 shows that, due to the tight nature of the reinforcing threads 3 from which the layer 2 is made up, or even the threads 5 making up layer 4, the new product 1 forms a mesh network in which the two component layers are each set up in its plane such that there no warp shrinkage in the finished product, as occurs with interlacing or intersections of woven fibres.

This type of new product is capable of supplying improved reinforcing characteristics due to its tight threads and also has plane faces that form a finished or semi-finished part in which at least one of the faces must have a uniform, smooth and regular appearance. This type of result may then be obtained by arranging the new product, when it is used for reinforcing purposes, such that the layer 2 is oriented towards the face which is required to have a smooth and uniform surface condition. Therefore the product 1 according to the invention is perfectly suitable for use as reinforcement for resins or bitumen.

In particular, the new product 1 according to the invention may be used for reinforcement by being completely embedded in a matrix or simply associated with an infill material on a single face.

Therefore, the purpose of this invention is composite parts composed at least partly of a reinforcing product 1 according to the invention combined with a matrix made of a thermoplastic or thermoset material. These parts are not necessarily obtained by moulding and conformation, but usually by injection of resin into the reinforcing product 1.

The reinforcing product 1 according to the invention may be used for making sliding sports equipment, skis or windmill blades or pultruded elements.

The invention is not limited to the examples described and represented, since various modifications can be made to it without going outside its scope.

1- Reinforcing product (1) comprising a first layer (2) of reinforcing threads (3) parallel to each other and a second layer (4) of reinforcing threads (5) parallel to each other and transverse to the first layer (2, 2a),
characterized in that the reinforcing threads (3, 3a) in the first layer (2) are partially covered by a powder (7) based on a thermoplastic or thermosetting material forming a bond firstly at points between the reinforcing threads (3) in the first layer (2), and secondly between the reinforcing threads (3) in the first layer (2) and the reinforcing threads (5) in the second layer (4).

2- Reinforcing product (1) according to claim 1, characterized in that it comprises a third layer (2b) of reinforcing threads (3b) parallel to each other and transverse to the first layer (2a), the reinforcing threads (5) in the second layer (4) being trapped between the reinforcing threads (3a, 3b) of the second (2a) and third (2b) layers and reinforcing threads (3b) in the third layer (2b) being partially covered by a powder (7) forming a bond firstly at points between the reinforcing threads (3b) in the third layer (2b ), and secondly between the reinforcing threads (3b) in the third layer (2b) and between the reinforcing threads (5) in the second layer (4)t.

3- Reinforcing product (1) according to claim 1, characterized in that the powder (7) covers less than 5%, and preferably less than 0.5%, of the surface area of the reinforcing threads (3a, 3b) in the first layer (2a) and possibly in the third layer (2b).

4- Reinforcing product (1) according to claim 1, characterized in that the reinforcing threads in each of the layers are adjacent to each other.

5- Reinforcing product (1) according to claim 1, characterized in that the reinforcing threads in each of the layers are arranged in roving to form a mesh.

6- Reinforcing product (1) according to claim 5, characterized in that the spacing of the roving in each of the layers is uniform and is between 0.5 and 20 cm.

7- Reinforcing product (1) according to claim 5, characterized in that roving of reinforcing threads (3a, 3b) in the first (2a) and in the third (2b) layers is coincident in superposed planes.

8- Reinforcing product (1) according to claim 5, characterized in that the roving of reinforcing thread (3a) in the first layer (2a) is offset by a half spacing from the roving of reinforcing thread (3b) in the third layer (2b).

9- Reinforcing product (1) according to claim 1, characterized in that the powder (7) is composed of grains (8) with an average diameter of between 50 and 500 μm.

10- Reinforcing product (1) according to claim 1, characterized in that the density of the powder (7) is between 0.9 and 2 g/cm³ and in that the mass of the powder (7) corresponds to 1 to 10% of the total mass of the reinforcing product (1).

11- Reinforcing product (1) according to claim 1, characterized in that the powder (7) is based on a thermosetting material selected from the group consisting of epoxy resins, urea-formol, vinyl polyacetate and unsaturated polyesters.

12- Reinforcing product (1) according to claim 1, characterized in that the powder (7) is based on a thermoplastic material selected from the group consisting of polyethylene terephthalate, polyamides, ethylenevinylacetate, and polyolefin resins.

13- Reinforcing product (1) according to claim 1, characterized in that the reinforcing threads (3a, 3b, 5) are made from a material selected from the group consisting of glass fibre, carbon, aramide, high strength polyethylene terephthalate and polyamide.

14- Reinforcing product (1) according to claim 1, characterized in that the reinforcing threads (3a, 3b, 5) are completely or partly textured or expanded.

15- Reinforcing product (1) according to claim 1, characterized in that it is associated with a surface or visible film on one or two of its faces.

16- Method for manufacturing a reinforcing product (1) according to claim 1, comprising the steps of:
a) a first layer (2, 2a) of reinforcing threads (3,3a) parallel to each other, is made and then passed in powder (7) based on a thermoplastic or thermosetting material,
b) the first layer (2, 2a) thus obtained is vibrated, in order to eliminate some of the powder (7) deposited on the surface of the reinforcing threads (3, 3a),
c) a second layer (4) of reinforcing threads (5) parallel to each other is deposited on the first layer (2, 2a), the second layer (4) transverse to the first layer (2, 2a) without interlacing, and
d) the two layers (2, 2a, 4) are assembled by thermocompression.

17- Method according to claim 16, characterized in that step c) is preceded by a step in which the first layer (2, 2a) is heated to a temperature just sufficient to soften the powder (7), and thus improve its attachment to the reinforcing threads (3, 3a).

18- Method according to claim 16, characterized in that the powder (7) is formed of grains (8) with an average diameter of between 50 and 500 μm.

19- Method according to claim 16, characterized in that the powder (7) is based on a thermoplastic material selected from the group consisting of polyethylene terephthalate, polyamides, ethylenevinylacetate, and polyolefin resins.

20- Method according to claim 16, characterized in that the powder (7) is based on a thermosetting material selected from the group consisting of epoxy resins, urea-formol, vinyl polyacetate and unsaturated polyesters.

21- Method according to claim 16, characterized in that after step b), the powder (7) covers less than 5%, and preferably less than 0.5% of the surface area of the reinforcing threads (3, 3a) in the first layer (2, 2a).

22- Part composed at least partly of a reinforcing product (1) according to claims 1 and a matrix made of a thermoplastic or thermoset material in relation with the reinforcing product (1).
